(19) United States
(12) Patent Application Publication
(10) Pub. No.: US 2005/0191435 A1
(43) Pub. Date: Sep. 1, 2005

(54) Method for improving the barrier properties of plastic containers

(76) Inventor: Bernard D. Bauman, Katy, TX (US)

Correspondence Address: SANFORD J. PILTCH, ESQ., 1132 HAMILTON STREET, SUITE 201, ALLENTOWN, PA, 18101, US

(21) Appl. No.: 11/070,977

(22) Filed: Feb. 28, 2005

Related U.S. Application Data
(60) Provisional application No. 60/548,659, filed on Feb. 27, 2004.

(51) Int. Cl. B05D 3/00

(52) U.S. Cl. 427/532

(57) ABSTRACT

A method for forming plastic packaging products (containers, tanks, etc.) that have a surface which has been subjected to a reactive gas atmosphere containing F₂, Cl₂, O₂, O₃, or SO₃, oxidative acids, or mixtures thereof, at a temperature and gas partial pressure sufficient to increase the surface energy to at least 40 dynes/cm in order to provide adhesion of the barrier coating, or molding the container in plastic resin that was first surface modified by one of the preceding processes and molded under conditions such that a surface is developed on the container that has a minimum of 40 dynes/cm and which will adhere well to coatings. A barrier coating is then applied. The barrier coating may be of various polymers and blends, all meeting the critical requirements that the coating must adhere tenaciously to the surface, must have good barrier properties for the molecules which are to be contained, and must not diminish the impact resistance of the material to which it is applied.

### CROSS-REFERENCE TO RELATED APPLICATION

This application is a continuation-in-part of U.S. provisional patent application accorded Ser. No. 60/548,659, filed Feb. 27, 2004.

### BACKGROUND OF THE INVENTION

The technical field of the present invention relates to a method for forming plastic packaging products (containers, fuel tanks, etc.) that have superior barrier properties to reduce the permeation of organic materials and gases, and also have excellent impact resistance.

Polyethylene and other types of plastics have found increasing use as replacements for glass and metal containers in packaging. Advantages of such plastic containers over metal include lighter weight, greater impact (puncture) resistance, ability to make complex shapes, corrosion resistance, and potentially lower costs. Notwithstanding the above, shortcomings in organic and gas barrier properties of polyethylene and polypropylene present major limitations to use for containing many types of products that include gasoline, gasohol, several organic liquids, oxygen, and carbon dioxide.

Polyethylene has been widely used to make automotive, marine, and other fuel tanks. Gasoline and gasohol permeate through the walls of the polyethylene tanks. Because these escaping organic materials are a form of environmental pollution, governmental regulations have been created to reduce this source of pollution. However, as environmental regulations further restrict the allowable permeation loss through the tank and container walls, and as the composition of automotive fuel changes, the existing technologies are proving inadequate for many tanks and containers.

Various technologies have been developed to reduce the permeation of gasoline, gasohol, and other organic materials through polyethylene and other plastic containers. Examples of these barrier-enhancing technologies include fluorination, sulfonation, addition of nylon to the plastic compound, co-extrusion with barrier plastics, and coating the interior and/or exterior surface with an appropriate barrier coating. For example, U.S. Pat. No. 3,862,284 discusses a process whereby the barrier properties of blow molded thermoplastic articles are improved by employing a blowing gas containing about 0.1 to about 20% by volume fluorine during expansion of the parison. U.K. Patent 2,069,870 B discloses a process for improving the barrier properties of polymeric containers by treating at least one surface of the container with sulfur trioxide, followed by washing with an aqueous medium and subsequently applying a layer of a dispersion melamine-formaldehyde or urea-formaldehyde condensation product. The dispersion layer is then cured to form the final product.

There are four basic molding processes that can be used to form a plastic container: blow molding, injection molding, rotational molding, and thermoforming. However, many of the technologies developed to date for improving the barrier properties of plastic containers are only applicable to containers molded by specific processes. For example, co-extrusion of the barrier material is not applicable to rotational molding. Likewise, the addition of polyamide particles is not effective for containers made via rotational molding or injection molding. In addition, not all barrier-enhancing technologies are effective for all products being contained. For example, fluorination and sulfonation processes are not very effective in reducing the permeation of gasohol (gasoline with 15% ethanol).

Another technology for improving the barrier performance of some plastic containers is the application of a barrier coating. For example, U.S. Pat. Nos. 5,006,381 and 5,008,137 describe the development of coated plastic containers with superior barrier properties, whereby all of the coatings are variations of epoxy resins. U.S. Pat. No. 4,515,836 discloses a process for providing a substrate such as a polyethylene terephthalate container with a gas barrier coating of a copolymer of vinylidene dichloride. The outside surface of the container is impacted with a stream of stabilized aqueous polymer dispersion with sufficient force to cause selective destabilization of the dispersion at the surface to form a gel layer containing the polymer in the continuous phase. The gel layer serves as an adhesive layer for an overlaying layer of the aqueous polymer dispersion as a continuous uniform coating.

Barrier coatings are not typically used on polyethylene and other polyolefin containers, however, because these polymers have poor adhesion to coatings. In the development of technology for enhancing the adhesion of the barrier coatings to the polyethylene and polyolefins, it was discovered while the coatings have excellent barrier properties, they cause significant loss in impact resistance, which is especially important for fuel tanks and other containers carrying flammable liquids. In none of the prior art teachings of barrier coatings is the loss of impact resistance mentioned, nor is it solved. In order for barrier coatings to be used on polyethylene and other polyolefin containers, it was necessary to develop methods for obtaining excellent adhesion of the coating to the plastic, and at the same time, not destroy the impact resistance of the container.

### SUMMARY OF THE INVENTION

The present invention is a composition of matter and method of forming containers and tanks made wholly or in part with polyethylene and other polyolefins combined with a surface modification step to either the raw material or pre-formed container or tank to provide excellent adhesion and application and curing of a coating, such that the coatings adhere very well, provide good barrier properties, and retain the important property of impact resistance. In order to achieve the adequate adhesion to polyethylene and other polyolefin containers and tanks, it is necessary to modify the chemical structure of the surface in a way that creates oxygen containing functional groups on the surface. Examples of appropriate oxygen-containing functional groups include hydroxyl (—OH), carboxyl (—CO₂—) and hydroperoxy groups (—O—O—). Furthermore, there must be sufficient concentration of these oxygen-containing functional groups on the surface such that the surface energy is at least 40 dynes/cm.

Methods for modifying the plastic surface to achieve this requirement include exposure to reactive gas atmosphere containing F₂, Cl₂, O₂, O₃, or SO₃, exposure to oxidative acids such as sulfuric and nitric acid, exposure to highly oxidative liquids such as hydrogen peroxide or chromic acid, plasma treatment, corona treatment, or flame treatment. Surface modification of the plastic resin may be performed on the raw material, prior to molding of the tank or container, or after molding. After surface modification, the barrier coating is then applied to the exterior surface of the molded container. The molded container may be coated with the coating by being immersion dipped in the coating, brushed, or sprayed, as either a liquid or a powder, on to the surface, then cured at the appropriate curing temperature, depending on the type of coating used.

Barrier coatings can be made in different types of polymers and blends. Examples include epoxies, novolacs, polyvinylidene dichloride, poylvinylchloride, polyacrylonitrile, polyurethane, polyurea, urea-formaldehyde, organopolysiloxane, unsaturated polyesters, and various copolymers and blends containing these. However they are chosen, each barrier coating must meet several critical requirements, including (1) coatings must adhere tenaciously to the surface of the treated plastic; (2) the coating must have good barrier properties for the molecules that are to be contained (oxygen, carbon dioxide, hydrocarbons, etc.); and (3) the coating must have a physical property that does not significantly diminish the impact resistance of the plastic to which it is applied.

### BRIEF DESCRIPTION OF THE DRAWING

For the purpose of illustrating the invention, there is shown in the drawing a resulting test, in chart form, of the forms of the invention that are presently preferred; it being understood, however, that the invention is not limited to the precise arrangements and instrumentalities shown.

FIG. 1 is a chart that is representative of the test results for ductility and brittleness failure of the barrier coatings surrounding plastic containers of the present invention.

### DETAILED DESCRIPTION OF THE PREFERRED EMBODIMENTS

The following detailed description is of the best presently contemplated mode of carrying out the invention. The description is not intended in a limiting sense, and is made solely for the purpose of illustrating the general principles of the invention. The various features and advantages of the present invention may be more readily understood with reference to the following detailed description.

This invention provides for a container or tank made wholly, or in part with polyethylene and other polyolefins that have been provided with a surface treatment to either the raw material or to the finished product in order to provide for excellent adhesion of the barrier coating and yet maintain impact resistance of the formed article. As stated earlier, the surface treatment can be applied to either small particle or granular raw material with the treated material then used in a molding process, or to a formed container that has already been molded. The surface treatment process will vary depending on the physical size of the article or material to be treated. If starting with very small particles of a raw material, i.e., granularized or of small, fine Mesh sizings, then the material to be treated is exposed to a reactive gas atmosphere containing F₂, Cl₂, O₂, O₃, or SO₃ oxidative acids, or a mixture thereof, or to plasma.

The preferred method is to use a reactive gas atmosphere containing fluorine gas. One way to use a reactive gas atmosphere for surface modification is to place the material or container in a chamber and add the reactive gas atmosphere. After sufficient exposure time, the reactive gas atmosphere and its subsequent by-products are removed and the plastic material or container item is removed from the chamber.

One approach for admitting the reactive gas atmosphere is to create a partial vacuum in the chamber and then flow the reactive gas into the chamber. It is possible to flow a pre-mixed blend of gases into the chamber, or to flow just the most reactive component into the chamber such that it becomes blended to the desired gas composition in the chamber. Following adequate exposure time, the reactive gases in the chamber can be removed by a series of steps consisting of (1) pulling a vacuum or reducing gas pressure within the chamber, followed by (2) addition of air or another inert gas or fluid. Alternatively, the reactive gas can be removed with a constant flow of air (or another inert gas) into the chamber, allowing for constant removal of the chamber's gas contents through a second orifice.

Another approach for getting a reactive gas atmosphere into a chamber is through a flow-through method. In this approach, a plastic container is placed in the chamber and a pre-blended mixture of reactive gas is continuously flowed into the chamber through an orifice. At the same time, the gas contents of the chamber are allowed to flow out of the chamber through a second orifice. After adequate exposure time, air, or some other inert gas or fluid, can be introduced and flowed through the chamber to sweep away the reactive gases. In all processes that utilize reactive gas treatment, it is desirable to pass the gas atmosphere through a scrubber prior to discharging to the atmosphere in order to remove any toxic and reactive species.

In one preferred method, a molded polyethylene fuel tank is placed in a reaction chamber (24×25×30 inches), and the chamber is sealed. A vacuum pump is used to reduce the pressure inside the chamber from 760mm (1 atm) to 745 mm. From a cylinder of 100% gaseous fluorine attached to the chamber, fluorine gas is added until the pressure within the chamber is 760 mm. The atmosphere is left in contact with the plastic container for ten (10) minutes. A vacuum is then pulled on the chamber until the pressure reaches 5 mm. At that point air is admitted into the chamber until the pressure reaches 760 mm again. This vacuum/air addition is done two more times. The chamber is then opened, and the surface modified plastic tank is then ready to be coated.

In another preferred embodiment, the treatment is carried out in a reactor in which the material is contacted with the chlorine-containing gas at a temperature from about 32° F. (0° C.) to about 200° F. (93.3° C.), with the reaction pressure being preferably within the range of from about 1 atm to about 10 atm. The chorine-containing gas will generally comprise from about 5% chorine by volume to substantially pure chlorine. Preferably the chlorine-containing gas will generally comprise from about 8% to about 50% by volume, although such concentrations are not deemed critical. Since the diffusion and reaction rate of the chlorine with the material is a function of concentration and pressure of the chlorine, the more encompassing definition of preferable chlorine concentrations for treating the material would be the partial pressure of the chlorine. Measured in this manner, the partial pressure of the chlorine should preferably be within the range of from about 0.05 atmospheres absolute (corresponding to a 5% concentration of chlorine in a system at atmospheric pressure) to about 0.5 atm. Absolute. The other components referred to as diluents, of the chlorine-containing gas, may comprise air or other inert gases such as nitrogen. Preferably the diluent comprises substantially nitrogen. The contact time will depend upon the material being used, either the granulated raw material and it's size, or the size of the pre-molded container since the gas must diffuse into the bulk of the particles, and also upon the reaction gas chlorine concentration, temperature and pressure. Preferably, this is in the range of about 20 seconds to about 60 minutes. Certain reaction conditions, such as higher temperature, pressure, or chlorine partial pressure could result in shorter required exposure times for desired surface energy increases.

The chlorine-containing gas may be used in either a batch reaction mode with an initial charge of gas containing sufficient chlorine for treatment, or may be added continuously throughout the reaction. There are a number of ways to provide contact between the chlorine-containing gas and the material, depending upon the material being used. If granular raw material is used, contact between the chlorine-containing gas and the granular material is best achieved by tumbling the granular material within the reactor or by using the chlorine-containing gas to fluidize the granular material. If a pre-molded tank is being used, both the chlorine-containing gas and material are added to and then taken from the reactor. After suitable reaction time, the molded container is taken from the reactor and purged, if necessary, of unreacted chlorine gas by a suitable purge gas, preferable either an air or nitrogen purge.

Reactive liquids can also be used to treat the material in order to create the correct functional oxygen groups on the surface. Examples of oxidative liquids that can be used include hydrogen peroxide, potassium permanganate, sulfuric acid, and fuming nitric acid. Surface modification can be performed with these liquids by either dipping the containers into the liquids, or by coating the liquids onto the surface. In either method, it is necessary to maintain sufficient contact time in order to achieve the amount of surface functionalization required. After treatment with the surface-modification liquid, the containers are usually rinsed with water and allowed to dry prior to coating.

Other surface modification treatments that can be used include plasma treatment, corona treatment, flame treatment, or radiation. Plasma treatment modifies the surface by placing the container in a chamber and exposing it to a plasma. Plasmas are generated when electrical energy is applied to a gas, usually at low pressures, which then results in the formation of high-energy reactive gases that readily react with polymer surfaces. Corona treatment involves causing an electrostatic discharge to occur at the polymer surface that is to be treated, usually performed at ambient temperatures. Flame treatment involves a burner, fueled by a gaseous fuel such as methane, natural gas, acetylene, etc, and is placed over the surface of the plastic surface such that the plastic surface is chemically oxidized, but not melted. Other sources of high-energy radiation may also be used, such as exposure to x-ray and ultraviolet light.

After surface modification treatment is completed, the barrier coating may be applied. If the surface treatment was performed on the plastic resin in the form of powder or pellets prior to molding the resin into the shape of the container, and if the container is molded under conditions such that a surface is created on the container that is adequate for good adhesion, then the molded container can be coated with a barrier material without performing a surface modification on the container.

The barrier coating may be applied by any of the processes that are known to the coatings industry. These include spray coating, dipping, applying with a brush or roller, powder coating, and vapor deposition. The coatings may be 100% solids (no solvents), or they could be dissolved or suspended in an organic liquid and/or aqueous material. The coatings can then be cured by any of the technologies known in the coatings industry. These include thermal cure (either ambient or elevated temperature), UV light cure, exposure to other sources of radiation energy (electron cure), or exposure to other chemicals that catalyze cure. Curing time will depend upon the method and material used.

The barrier coating can be chosen from various materials, as long as they meet several critical requirements. However they are chosen, each barrier coating must meet several critical requirements, including (1) the coating must not have a surface tension that is greater than 73 dynes/cm; (2) coatings must adhere tenaciously to the surface of the treated plastic; (3) the coating must have good barrier properties for the molecules that are to be contained (oxygen, carbon dioxide, hydrocarbons, etc.); and (4) the coating must have a physical property that does not significantly diminish the impact resistance of the plastic to which it is applied.

The final product can be tested for impact resistance and permeation. The impact resistance can be determined in a variety of ways. These methods include testing coated plastic coupons or samples in conventional impact test equipment, such as Charpey, Izod, and Dynatup, and testing entire containers via a drop test and other methods of impacting the container. One preferred testing method uses an instrumented drop weight tester. Using this technique, the kinetic energy of a falling impactor is measured continuously by measuring its velocity at each millisecond as it impacts a plastic coupon. By knowing the kinetic energy of the impactor at any given time, one can calculate the amount of energy that has been transferred to the plastic. The shape of the impactor kinetic energy versus time curve shows how much force is required to break the sample and clearly shows a difference between brittle and ductile plastic failure.

In addition, the improved barrier properties of the plastic container can be quantified by several methods. Most tests involve putting a test liquid, in this case, a fuel, in the container, sealing the container, and then performing the various tests. One preferred test measurement of the barrier properties is a gravimetric approach, whereby the fuel-containing container is weighed over time, and the weight loss equals the amount of liquid that has permeated out. Another way to test the permeability of the container is to place the fuel-containing container in a chamber and quantitatively measure the amount of liquid (fuel) in the air space around the container, typically performed via gas chromatography or with a flame ionization detector. It is also possible to measure permeation of plastic-coated samples by putting them in a permeation cell, with the permeating liquid on one side, and allowing the liquid to permeate through the sample. The rate of permeation is determined by quantifying the amount of liquid in the gas stream on the outside, or by measuring the weight loss of the cell.

Whichever test method is employed, it is important to allow the permeation to reach steady state equilibrium in order to get meaningful results. Also, it is common practice to perform this test at an elevated temperature (such as 50° C.) to speed up the results. Correlation factors can then be applied to estimate the rate of permeation at lower (ambient) temperatures.

The following Examples were made in order to demonstrate the efficacy and utility of the various methods for producing a suitable barrier coating. The adhesion of coatings on plastic surfaces was tested according to ASTM D-3359-78. This test consisted of making a series of spaced apart parallel razor cuts in the horizontal and vertical directions to form 100 squares, termed a crosshatch. Next a piece of Scotche Brand cellophane tape was applied over the crosshatch, smoothed firmly, and then peeled from the crosshatch. The number of crosshatch squares remaining on the coated surface was counted. Adhesion levels are assigned according to the TABLE 1 below, with Adhesion Level 5 being acceptable.

TABLE 1
ADHESION LEVELS FOR ASTM D-3359-78 TEST

| SCALE | % OF SQUARES REMAINING |
|---|---|
| 5 | 100 |
| 4 | 95+ |
| 3 | 85+ |
| 2 | 65+ |
| 1 | 35+ |
| 0 | 0-35 |

### EXAMPLE 1

Coating experiments were performed on injection molded 5-gallon high-density polyethylene (HDPE) tanks. Some of these tanks were used as received—the controls. The surface energy of the exterior surface of the control tanks was measured as 28-30 dynes/cm, using ACCU DYNE TEST™ marker pens manufactured by Diversified Enterprises of Claremont, N.H. Some of these tanks were surface modified by fluoro-oxidation chemistry. This was done by placing tanks in a reactor and exposing them to an atmosphere consisting of 5% (volume) F₂/95% (volume) air at ambient temperature for 15 minutes. After treatment, the surface energy of the exterior surface of the tanks was measured as 58-60+ dynes/cm, using ACCU DYNE TEST™ marker pens. Some of the tanks were surface modified via flame treatment. This was performed by playing the flame from a butane torch over the exterior of the tanks. After treatment, the surface energy of the exterior surface of the tanks was measured as 42-48 dynes/cm, using ACCU DYNE TEST™ marker pens.

An epoxy coating was applied to the exterior surface of these 3 types of tanks. The coating was composed of 100 parts (by weight) Bis A type epoxy resin, D.E.R. 324 from Dow Chemical Company and 12.9 parts triethylene tetramine—TETA, D.E.H. 24 from Dow Chemical Company. After the coating was fully cured, the adhesion on these tanks was measured using the ASTM D-3359-78 crosshatch test. The results from these adhesion tests are summarized in TABLE 2 below.

TABLE 2

| | SURFACE ENERGY | ASTM ADHESION |
|---|---|---|
| TANK TREATMENT | (dynes/cm) | RATING |
| Control | 28-30 | 0 |
| Fluoro-oxidation | 58-60+ | 5 |
| Flame | 42-48 | 5 |

These results show that two very different surface modification processes can be used to increase the surface energy, and that an increase in surface energy is required for excellent adhesion of an epoxy coating to a plastic surface.

### EXAMPLE 2

This series of experiments involved use of 12-oz oriented polypropylene jars, made by stretch blow molding. Some of these jars were used without surface modification—controls. Some of the jars were fluoro-oxidized by exposing the jars to an atmosphere consisting of 2.5% (volume) F₂/97.5% (volume) air at ambient temperature for 10 minutes. Using ACCU DYNE TEST™ Marker Pens, the surface energy of the control jars was measured as 28-32 dynes/cm, and the surface energy of the fluoro-oxidized jars was measured as 55-60+ dynes/cm.

Two types of coatings were used on these jars, polyvinyl alcohol (PVOH) and polyvinylidene chloride (PVDC) emulsion, (Daran® 8600 made by W.R. Grace and Company.) For some of the jars, a 10% by weight aqueous solution of polyvinyl alcohol was applied to the exterior surface and allowed to dry. Other jars were coated with a 50% by weight aqueous solution of highly crystalline PVDC and allowed to dry. After the coatings were fully cured, the adhesion on these jars was measured using the ASTM D-3359-78 crosshatch test. The results from these adhesion tests are summarized in TABLE 3 below.

TABLE 3

| PP JAR | SURFACE ENERGY | | ASTM |
|---|---|---|---|
| TREATMENT | (dynes/cm) | COATING | ADHESION |
| Control (none) | 28-32 | PVOH | 0 |
| Control (none) | 28-32 | PVDC | 0 |
| Fluoro-oxidized | 55-60+ | PVOH | 5 |
| Fluoro-oxidized | 55-60+ | PVDC | 5 |
| Fluoro-oxidized | 55-60+ | PVOH | 5 |
| Fluoro-oxidized | 55-60+ | PVDC | 5 |

These results show that polypropylene performs nearly identically to polyethylene as in EXAMPLE 1 in that without surface modification it has low surface energy and after surface modification its surface energy is significantly increased. It also shows that a high surface energy is required on polypropylene in order to achieve excellent adhesion. The data also shows that polyvinyl alcohol and PVDC coatings require a high surface energy on plastic being coated in order to achieve excellent adhesion.

### EXAMPLE 3

These tests were performed on 16 oz polyvinyl chloride (PVC) bottles r-iade by extrusion blow molding. Some of the bottles were used without surface modification (controls). Others were surface modified via fluoro-oxidation by exposing the bottles to an atmosphere consisting of 3% (volume) F₂/97% (volume) air at ambient temperature for 10 minutes. Using ACCU DYNE TEST™ Marker Pens, the surface energy of the control bottles was measured as 28-30 dynes/cm, and the surface energy of the fluoro-oxidized jars was measured as 57-60+ dynes/cm. The bottles were coated with the epoxy composition described above in EXAMPLE 1 and cured. Thereafter, adhesion was tested using the ASTM D-3359-78 crosshatch test. The results from these adhesion tests are summarized in TABLE 4 below.

TABLE 4

| SURFACE | SURFACE ENERGY | ASTM |
|---|---|---|
| MODIFICATION | (dynes/cm) | ADHESION |
| Controls (no treatment) | 28-30 | 0 |
| Fluoro-oxidized | 57-60+ | 5 |

These results show that plastic containers made in PVC also must be surface modified in order to acquire a high surface energy and to subsequently give excellent adhesion to a barrier coating.

### EXAMPLE 4

Impact testing was performed on plastic specimens to gain an understanding of how to minimize loss of impact resistance when coatings are applied to a plastic tank or container. It was anticipated that the coatings would degrade the impact resistance of the polymer by causing a brittle failure of the material. Impact testing was performed on coupon specimens made in high-density polyethylene (HDPE), in a thickness similar to the wall thickness of fuel tanks. The instrument used for this study was an instrumented load cell attached to a crosshead of a known weight and guided by two poles. The crosshead was raised to a predetermined height and released to impact upon the coupon. A photodetector measures the crosshead's impact velocity and triggers the recording system. The penetration data are acquired using a Dynatup® Drop Tower System with the associated Dynatup® Impulse software. The drop tower system consists of a drop weight (crosshead) with a calibrated and instrumented TUP (load cell) and indentor mounted below the drop weight. The indentor used for this test was a 1-inch diameter shaft, 3.25 inches long, with a 1-inch hemispherical tip. The coupons were all placed in a test fixture that securely held the edges of the four-inch square samples. The unsupported area at the center of the coupon was three-inches diameter. All of the tests were conducted at ambient conditions.

With the instrumentation and software associated with the described test apparatus, the speed of the indentor can be measured many times each millisecond, which enables calculation of instantaneous kinetic energy of the indentor during the time it penetrates the coupon's thickness, and also enables calculation of the energy absorbed by the plastic. Test coupons 4 inches×4 inches×⅛ inches molded in HDPE were used to quantify the impact resistance of the control and fluoro-oxidized samples. The fluoro-oxidized samples were exposed to an atmosphere consisting of 5% (by volume) fluorine (F2) and 95% (by volume) air, for 10 minutes. The surface energy and the impact resistance of treated and non-treated samples were compared. The data from the impact testing is summarized in TABLE 5 below.

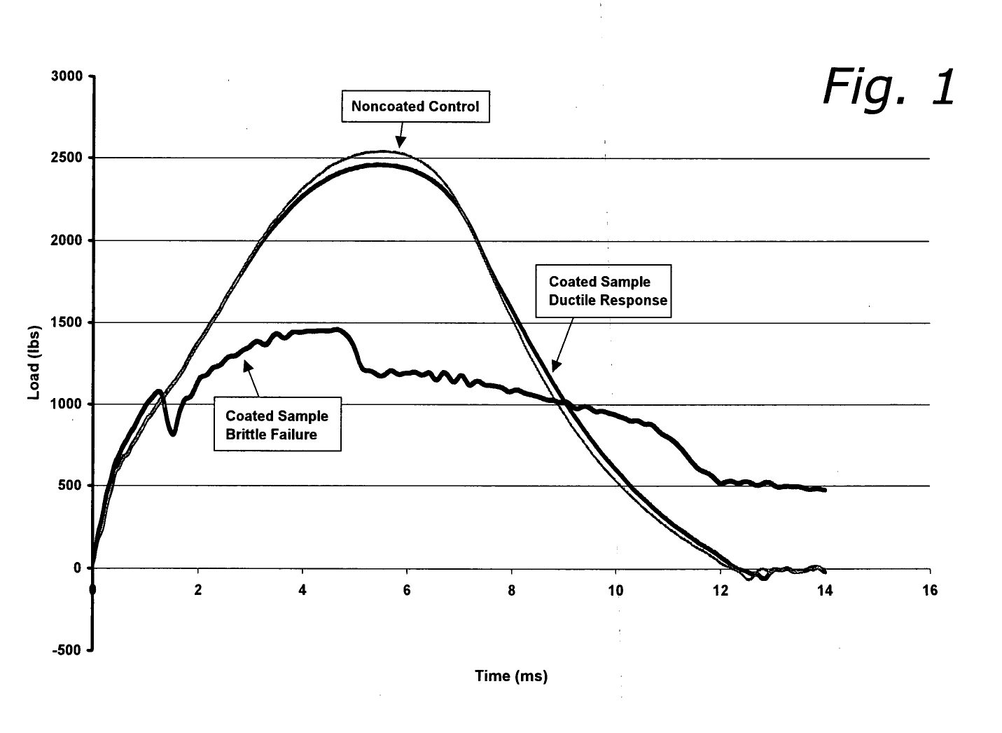

The tests showed that the impact performance of HDPE is unaffected by surface modification. All of the test specimens experienced ductile failure, but did not fail in a brittle mode (crack). The kind of results that were obtained from this instrumented impact test technique is illustrated in FIG. 1. When the plastic undergoes ductile deformation, the sample absorbs a high load. When a plastic undergoes brittle fracture, it withstands a much lower load. Furthermore, when a plastic undergoes ductile deformation, the plastic stretches and there is no loss in continuity of the surface. On the other hand, when plastic undergoes brittle fracture, it cracks all of the way through the sample coupon. Obviously brittle fracture is highly undesirable for containers holding flammable or toxic materials, such as fuel tanks holding gasoline. Our objective was to identify combinations of surface modifications and coatings that do not result in a brittle failure.

TABLE 5

| | SURFACE | IMPACT | IMPACT | MAX | TIME TO | DEFLECTION | ENERGY | TOTAL | VELOCITY |
|---|---|---|---|---|---|---|---|---|---|
| | ENERGY | ENERGY | VELOCITY | LOAD | MAX LOAD | AT MAX | TO MAX | ENERGY | SLOW |
| SAMPLE | (dynes/cm) | (ft lbf) | (ft/s) | (lb) | (ms) | LOAD (in) | LOAD (ft lbf) | (ft lbf) | DOWN (%) |
| Control | 30 | 24.38 | 8.02 | 1433.92 | 5.63 | 0.36 | 25.96 | 13.13 | 87.07 |
| Fluoro- | 60+ | 24.38 | 8.02 | 1418.30 | 5.69 | 0.37 | 25.95 | 13.83 | 86.82 |
| oxidized | | | | | | | | | |
| Control | 30 | 76.06 | 14.17 | 2461.02 | 5.41 | 0.65 | 75.56 | 53.46 | 79.88 |
| Fluoro- | 60+ | 76.34 | 14.20 | 2505.47 | 5.46 | 0.65 | 76.38 | 55.41 | 81.77 |
| oxidized | | | | | | | | | |

While such data was collected for these samples, it was determined that visual inspection of tested coupons was actually more straightforward. When coatings significantly reduced the impact resistance, the coupons experienced brittle failure. This is evidenced by dramatic cracking of the sample. This is obviously undesirable in containers that are holding flammable contents such as gasoline. In contrast, coupons that did not experience brittle failure simply deformed and retained surface continuity. Thus, in subsequent impact tests we focused on determining whether or not brittle fracture occurred.

### EXAMPLE 5

A series of HDPE sample coupons were prepared and impact tested as described in EXAMPLE 4. The samples were coated with versions of ultraviolet cured epoxy resins made by and applied by Crosslink Technology, Inc. of Mississauga, Canada. We examined coatings of different thickness and we examined impact on the coated surface and impact on the backside. The results are summarized in TABLE 6 below.

TABLE 6

| | COATING | | |
|---|---|---|---|
| COATING | THICKNESS | IMPACTED | DEFORMATION |
| TYPE | (mils) | SURFACE | MODE |
| None | N/A | N/A | Ductile (passed) |
| S | 4 | Front | Ductile (passed) |
| S | 4 | Back | Brittle (failed) |
| S | 12 | Front | Brittle (failed) |
| S | 12 | Back | Brittle (failed) |
| T | 3 | Front | Ductile (passed) |
| T | 3 | Back | Brittle (failed) |
| T | 7 | Front | Ductile (passed) |
| T | 7 | Back | Brittle (failed) |

Important discoveries came with the above data. It was demonstrated that coated plastic is much more resistant to brittle fracture when the impact is on the coated surface as opposed to the backside of the coating. The relevance of this to coating containers for improved barrier properties is that impact resistance is far better when the coating is on the exterior of the container. This is because most impact damage is expected to arise from objects hitting the outside of tanks and other containers. The second important discovery is that thicker coating layers are more prone to causing brittle fracture than are thin coatings. The data indicates that optimal impact resistance is maintained with coatings that are less than 12 mils think.

### EXAMPLE 6

The barrier performance of various containers was quantified by putting a test liquid, typically gasoline or gasohol, in containers, sealing them, placing them in temperature-controlled environment, and weighing them periodically. In this test we quantified the performance of untreated containers, containers that were surface modified to give a surface energy in excess of 60 dynes/cm, and containers that were surface modified and then coated with a barrier coating. For this study we only coated containers that were first surface modified because it is critical that the adhesion of the coating to the containers be strong and durable. Permeation of fuel through the container walls was quantified by the weight loss. In one study, we used 16 oz blow molded HDPE containers. All of these were fluoro-oxidized to give a surface energy in excess of 55 dynes/cm, as measured by ACCU DYNE TEST™ Marker Pens. Control bottles were not coated. The coated bottles were coated on the exterior surface with an epoxy composed of 100 parts (by weight) Bis A type epoxy resin, D.E.R. 324 from Dow Chemical Company and 12.9 parts triethylene tetramine—TETA, D.E.H. 24 from Dow Chemical Company. The thickness of the coatings on these bottles was 10 mils. The coatings were cured by placing in an oven at 70° C. for 8 hours. Between 3 and 5 samples of each bottle/coating/permeation liquid were used. Data from bottles that were obviously leaking was discarded. The data from the same groups of samples were averaged. Two types of liquids were used; gasoline obtained from local distributors, and gasoline plus 10% (by volume) ethanol, commonly termed gasohol. After being on test for 21 days, it was determined that steady state permeation rates had been achieved in all samples. The average weight loss per day for each type of test containers is summarized in TABLE 7 below.

TABLE 7
FUEL PERMEATION THROUGH 16 oz HDPE BOTTLES

| | |
|---|---|
| GASOLINE | GASOHOL |

g/m²/day

| | | |
|---|---|---|
| Control | 76.0 | 68.0 |
| Fluoro-oxidation only | 2.5 | 8.0 |
| Fluoro-oxidation/epoxy coating | 0.2 | 0.1 |

These results show that surface modification alone has a significant effect in reducing the permeation of fuel through the plastic containers. The results also show that a barrier coating in combination with the surface modification provides even greater barrier performance.

### EXAMPLE 7

This experiment consisted of using eighteen 1-gallon portable fuel tanks blow molded in high-density polyethylene. All of the tanks were surface modified such that they had surface energy in excess of 55 dynes/cm. Sixteen were then coated on the outside with one of two uv-cure epoxy coatings that were developed, applied, and cured by Crosslink Technologies, Inc. One coating was designated as S-type and the other was designated as T-type. The coating thickness was 9-11 mils for both coatings. Eight of these tanks (4 with each type of coating) were filled ¾ full with gasoline (Cert Fuel) and eight (4 with each type of coating) were filled ¾ full with a mixture of 90% (by volume) gasoline and 10% ethanol. In addition, two tanks were surface modified but not coated, to serve as controls. The tanks were sealed and placed in an oven at 40° C. The weight of these tanks was measured at least once per week over the next 24 weeks. After that time all of the tanks had achieved steady state permeation, as evidenced by the fact that the weight loss/day for each was constant for the preceding several weeks. Knowing that the surface area of each tank was 265.5, the weight loss of each tank was calculated in terms of weight loss/m²/day. The results are summarized in TABLE 8 below.

TABLE 8

| | | WEIGHT LOSS |
|---|---|---|
| COATING TYPE | PERMEANT | (g/m²/day) |
| CONTROL | GASOLINE | 7.72 |
| CONTROL | GASOHOL | 7.08 |
| S-TYPE | GASOLINE | 0.269 |
| | | 0.109 |
| | | 0.076 |
| | | 0.487 |
| | AVERAGE | 0.235 |
| S-TYPE | GASOHOL | 0.370 |
| | | 1.218 |
| | | 1.882 |
| | | 0.756 |
| | AVERAGE | 1.060 |
| T-TYPE | GASOLINE | 2.664 |
| | | 0.513 |
| | | 3.387 |
| | | 2.655 |
| | AVERAGE | 2.306 |
| T-TYPE | GASOHOL | 1.042 |
| | | 2.017 |
| | | 1.076 |
| | | 1.000 |
| | AVERAGE | 1.280 |

This data shows that barrier coatings applied to surface modified plastic and cured with ultraviolet radiation can significantly increase the container's barrier properties for a variety of fuels.

The present invention may be embodied in other specific forms without departing from the spirit or essential attributes thereof and, accordingly, the described embodiments are to be considered in all respects as being illustrative and not restrictive, with the scope of the invention being indicated by the appended claims, rather than the foregoing detailed description, as indicating the scope of the invention as well as all modifications which may fall within a range of equivalency which are also intended to be embraced therein.

1. A method for increasing the barrier properties of a plastic container and for retaining said container's impact resistance properties comprising the steps of:
a. performing surface modification on the container such that the surface energy of the exterior surface of said container is in excess of 40 dynes/cm at a temperature of 20 degrees C.;
b. applying to the surface modified exterior surface of the container a barrier coating selected from the group consisting essentially of epoxy, vinyl alcohol, ethylene vinyl alcohol, vinyl ester, polyamide, polyurea, polyurethane, silicone, and fluorocarbon;
c. applying the barrier coating to a dry film thickness no greater than 12 mils; and,
d. curing said barrier coating.

2. The method in accordance with claim 1, wherein the plastic from which the container may be made is selected from the group consisting essentially of, or co-extruded with, polyethylene, polypropylene, polyamide, polyvinyl chloride, polyester, vinyl ester, polyurethane, polyurea, and copolymers thereof.

3. The method in accordance with claim 1, wherein said plastic container is formed as a fuel tank.

4. The method in accordance with claim 1, wherein the surface modification is performed by exposure of said surface to a gaseous atmosphere containing a gas selected from the group consisting of fluorine, sulfur trioxide, ozone, and chlorine.

5. The method in accordance with claim 1 wherein the surface modification is performed by a surface exposure technique selected from the group consisting of ionizing radiation, plasma, electrostatic discharge, ultraviolet light irradiation, and electron beam.

6. The method in accordance with claim 1, wherein the surface modification is performed by exposure of said surface to an oxidative liquid containing reactive components from the group consisting of sulfuric acid, nitric acid, hydrogen peroxide, and chromic acid.

7. The method in accordance with claim 1, wherein said container is pre-formed utilizing a process selected from the group consisting of rotational molding, injection molding, blow molding, thermoforming, resin transfer molding, or hand lay-up.

8. The method in accordance with claim 1, wherein the barrier coating is applied to the surface modified exterior surface of said container by an application technique selected from the group consisting of spray coating, flow coating, dip coating, brush application, roller application, and vapor deposition.

9. The method in accordance with claim 8, wherein the barrier coating material may be water borne, solvent borne, or of 100% solids.

10. The method in accordance with claim 1, wherein the barrier coating curing step may be performed at ambient temperature and at an elevated temperature.

11. The method in accordance with claim 1, wherein the barrier coating curing step may be performed with ultraviolet radiation.

12. A method for increasing the barrier properties of a plastic container and retaining said container's impact resistance properties comprising the steps of:
a. providing a plurality of polymer resin particles selected from the group consisting essentially of polyethylene and polypropylene, and copolymers thereof;
b. performing surface modification on the polymer resin particles prior to using said particles in a molding operation for forming said plastic container such that the surface energy of the exterior surface of said container is in excess of 40 dynes/cm at a temperature of 20 degrees C.;
c. forming said plastic container by rotationally molding under conditions whereby the exterior surface of the formed container obtains the surface energy of the polymer resin particles, said surface energy being in excess of 40 dynes/cm;
d. applying to the exterior surface of the formed plastic container a barrier coating selected from the group consisting essentially of epoxy, vinyl alcohol, ethylene vinyl alcohol, vinyl ester, polyamide, polyurea, polyurethane, silicone, and fluorocarbon;
e. applying the barrier coating to a dry film thickness no greater than 12 mils; and,
f. curing said barrier coating.

13. The method in accordance with claim 12, wherein said formed plastic container is a fuel tank.

14. The method in accordance with claim 12, wherein the surface modification is performed by exposure of said surface to a gaseous atmosphere containing a gas selected from the group consisting of fluorine, sulfur trioxide, ozone, and chlorine.

15. The method in accordance with claim 12, wherein the surface modification is performed by a surface exposure technique selected from the group consisting of ionizing radiation, plasma, electrostatic discharge, ultraviolet light irradiation, and electron beam.

16. The method in accordance with claim 12, wherein the surface modification is performed by exposure of said surface to an oxidative liquid containing reactive components from the group consisting of sulfuric acid, nitric acid, hydrogen peroxide, and chromic acid.

17. The method in accordance with claim 12, wherein the barrier coating is applied to the surface modified exterior surface of said container by an application technique selected from the group consisting of spray coating, flow coating, dip coating, brush application, roller application, and vapor deposition.

18. The method in accordance with claim 12, wherein the barrier coating material may be water borne, solvent borne, or of 100% solids.

19. The method in accordance with claim 12, wherein the barrier coating curing step may be performed at ambient temperature and at an elevated temperature.

20. The method in accordance with claim 12, wherein the barrier coating curing step may be performed with ultraviolet radiation.
